(19) United States
(12) Patent Application Publication
(10) Pub. No.: US 2019/0274011 A1
(43) Pub. Date: Sep. 5, 2019

(54) COMMUNICATION SYSTEM

(71) Applicant: NEC LABORATORIES EUROPE GMBH, Heidelberg (DE)

(72) Inventors: Takahito Yoshizawa, Heidelberg (DE); Genadi Velev, Darmstadt (DE); Andreas Kunz, Ladenburg (DE)

(21) Appl. No.: 16/338,506

(22) PCT Filed: Sep. 29, 2017
(86) PCT No.: PCT/EP2017/074895

§ 371 Date: Apr. 1, 2019

(30) Foreign Application Priority Data
Sep. 30, 2016 (EP) 16275148.1
Oct. 31, 2016 (EP) 16196669.2

(51) Int. Cl. H04W 4/08; H04W 72/00; H04L 12/18; H04W 40/24

(52) U.S. Cl. CPC H04W 4/08; H04W 40/246; H04L 12/189; H04W 72/005

(57) ABSTRACT

A method, performed by a multi-cell/multicast coordination entity (MCE) in a communication system in which a plurality of member user equipments (UEs) can engage in group communication, includes obtaining information about a supported multimedia broadcast/multicast service (MBMS) mechanism of a member UE of the plurality of member UEs. The obtained information is used to select a multimedia broadcast/multicast service (MBMS) mechanism for a base station (eNB). The selected MBMS mechanism is notified to an application server.

### CROSS-REFERENCE TO PRIOR APPLICATIONS

This application is a U.S. National Stage Application under 35 U.S.C. § 371 of International Application No. PCT/EP2017/074895 filed on Sep. 29, 2017, and claims benefit to European Patent Application Nos. EP 16275148.1 filed on Sep. 30, 2016, and EP 16196669.2 filed on Oct. 31, 2016. The International Application was published in English on Apr. 5, 2018 as WO 2018/060492 A1 under PCT Article 21(2).

### FIELD

The present invention relates to a communication system. The invention has particular but not exclusive relevance to wireless communication systems and devices thereof operating according to the 3rd Generation Partnership Project (3GPP) standards or equivalents or derivatives thereof. The invention has particular although not exclusive relevance to group communication over multicast and unicast services and to a method of delivering group communication in a mobile system.

### BACKGROUND

In 3GPP standards related cellular communication systems (e.g. Long Term Evolution (LTE)/Enhanced Packet Core (EPC) networks), to meet Public Safety community's needs, several new features have been introduced in 3GPP since Release 11. In Release 12, a GCSE_LTE (Group Communication System Enabler for Long Term Evolution (LTE)) was introduced. It is a framework that allows dynamic control of MBMS (Multimedia Broadcast/Multicast Service) traffic distribution for group communication in order to meet the Public Safety needs of mission-critical group communication. With the introduction of the GCSE_LTE, a new entity was defined—a GCS-AS (Group Communication System Application Server). The GCS-AS is an Application server that is expected to be under the control of the public safety entity (e.g. police dept., etc.) and thus it is likely that it resides outside the public land mobile network (PLMN). However, under a different arrangement between the PLMN and the public safety entity, it may reside under the PLMN. Its overall role is to manage group communication by interfacing with various NEs (Network Elements) in the 3GPP system.

The GCS-AS's functionalities include:

1) interfacing with a BM-SC (Broadcast-Multicast Service Center) to dynamically establish and tear-down MBMS sessions, and

2) determining whether the group communication user-plane (UP) data to a given UE (user Equipment) should be delivered using an MBMS method or a unicast method.

The second part implies that GCS-AS needs to have the appropriate information in order to determine which of the two delivery methods (i.e. MBMS or unicast) should be selected for a given UE for group communication. If the UP data is sent using MBMS, then the GCS-AS sends the data to BM-SC (over an MB2-U interface). If the UP data is sent using unicast, then the GCS-AS sends the data to the P-GW (Public Data Network (PDN) Gateway) over an SGi interface.

FIG. 1 schematically illustrates a mobile (cellular) telecommunication network in accordance with the system architecture of the GCSE_LTE as defined in FIG. 4.2.2-1 of 3GPP TS 23.468 v12.0.0 (“Group Communication System Enablers for LTE (GCSE_LTE); Stage 2”, February 2014 [1]).

In the GCSE_LTE architecture, a GC1 reference point is defined between the UE and a GCS-AS. The intent of this logical interface is for the UE and GCS-AS to exchange relevant information within the context of GCSE_LTE operation. Given that it is an application level interface between the UE and the AS in the Application domain, this interface may be carried over the SGi interface in reality.

In Release 13, another Public Safety feature, the SC-PTM (Single Carrier Point-to-Multipoint) feature, was introduced. The SC-PTM feature is an MBMS distribution mechanism that dynamically allocates radio resource at cell level to distribute MBMS traffic. This new mechanism was introduced because the existing MBSFN (Multicast Broadcast Single Frequency Network) mechanism was originally designed for a different purpose (TV broadcast service over cellular) and thus does not meet the needs of Public Safety. Specifically, an MBSFN covers a large pre-defined area (called an “MBSFN area”) including multiple base stations (eNBs), it occupies the entire channel spectrum and multiplexing with unicast traffic in the same subframe is not possible. The radio resource is statically configured by an O&M (operations and maintenance) function with no need or possibility to dynamically re-configure it [2][3]. Also, study of SC-PTM shows that it can improve spectrum efficiency over the MBSFN for a small number of UEs [2][4].

Contrary to TV broadcasting, Public Safety communication is typically more ad-hoc in nature and communication needs to be established in an on-demand basis in a relatively limited geographical area with limited number of participating users for limited period of time (e.g. an event of emergency situation handled by police and/or fire department officers in a specific location for a limited period of time). Clearly, the existing MBSFN mechanism is not suitable for the needs of Public Safety usage.

FIG. 2, corresponds to FIG. 6.1.3.2-1 of TS 36.300 v 13.2.0 (“Evolved Universal Terrestrial Radio Access (E-UTRA) and Evolved Universal Terrestrial Radio Access Network (E-UTRAN); Overall description; Stage 2”), December 2015 [5], illustrates DL logical channel mapping with the introduction of SC-PTM. As seen in FIG. 2, the SC-PTM feature introduces new logical channels in the Uu interface. Specifically, in FIG. 2, two new DL logical channels—SC-MTCH (Single Cell Multicast Traffic CHannel) and SC-MCCH (Single Cell Multicast Control CHannel)—have been introduced, and are mapped to a DL-SCH (DownLink Shared CHannel) transport channel. In addition, a new system information block (SIB—SIB 20) has been introduced to signal the control information associated with the location and periodicity of SC-MCCH in the radio frame.

FIG. 2 clearly shows that SC-PTM is a UE-impacting feature, meaning that appropriate UE support and implementation are required for this mechanism to work. UEs that do not support SC-PTM will not understand the newly introduced SIB and logical channels, and thus ignore them.

Thus, the introduction of SC-PTM mechanism to MBMS means that there are two mechanisms of distributing MBMS data traffic to the UEs:

1) the legacy MBSFN mechanism, and

2) SC-PTM mechanism (UE-impacting mechanism) which is introduced in Release 13.

The MBMS logical architecture is shown in FIG. 3 corresponds to FIG. 15.1.1-1 of TS 36.300 v 13.2.0 (“Evolved Universal Terrestrial Radio Access (E-UTRA) and Evolved Universal Terrestrial Radio Access Network (E-UTRAN); Overall description; Stage 2”), December 2015 [5]. As seen in FIG. 3, in MBMS, the RAN (i.e. the E-UTRAN in LTE) comprises a network element called an MCE (Multi-cell/multicast Coordination Entity) and an eNB. The MCE is responsible for selecting which of the two distribution mechanisms should be used for a given MBMS data (as defined in section 15.1.1 in [5]). As seen in FIG. 1, however, at the system architecture level the MCE is not explicitly shown as a separate network element. This also implies that the GCS-AS is not aware of the selection the MCE makes regarding the two distribution mechanisms for MBMS.

For the control plane, the reference point between the MME and MCE is the M3 reference point and the associated signaling protocol is M3AP [6]. The reference point between MCE and eNB is the M2 reference point and the associated signaling protocol is M2AP [7]. For the user plane, the reference point between MBMS GW and the eNB is the M1 reference point and the associated user plane protocol is GTP-U.

When SC-PTM was introduced in Release 13, additional IEs were added to M3AP and M2AP protocol messages in order to specify the specific list of cells for which the MBMS data for a given group communication need to be distributed. [6][7] These are “MBMS Cell List” IE in the M3AP: MBMS SESSION START REQUEST message and MBMS SESSION UPDATE REQUEST message [6], and “SC-PTM Information” IE in the M2AP: MBMS SESSION START REQUEST message and MBMS SESSION UPDATE REQUEST message [7].

From the MCE's perspective, upon determining the MBMS distribution mechanism, the MCE indicates the distribution mechanism to the eNB via the appropriate M2AP message(s) mentioned above. When the SC-PTM mechanism is selected, the MCE includes the “SC-PTM Information” IE in the M2AP message to the eNB. If MBSFN mechanism is selected, then the MCE does not include this IE. Therefore, from the receiving side of the M2AP message (i.e. the eNB), presence of this SC-PTM Information IE in the M2AP message indicates that the use of the SC-PTM mechanism is instructed by the MCE. Hence the eNB initiates the Uu interface procedure accordingly (deliver MBMS message using SC-MTCH, SC-MCCH logical channels). On the other hand, since the absence of the SC-PTM Information IE in the M2AP message indicates the legacy MBSFN mechanism has been instructed, the eNB delivers the MBMS message using the legacy Uu interface mechanism (delivery over MTCH, MCCH logical channels).

In addition, the UE's mobility may be taken into account upon selecting the delivery mechanism for the group message (i.e. MBMS or unicast). For example, the following scenarios may result in either failed or sub-optimal selection:
Selecting MBMS to a UE when it is under a cell coverage in which SC-PTM is used for MBMS delivery and this UE does not support it.
   This implies that the GCS-AS should select unicast for this UE.
Selecting unicast to a UE when it is under a cell coverage in which SC-PTM is used for MBMS delivery and this UE supports SC-PTM.
   This implies that the GCS-AS should select MBMS for this UE.
Selecting unicast to a UE when it is under a cell coverage in which MBSFN is used for MBMS delivery.
   This implies that the GCS-AS should select MBMS for this UE.

### SUMMARY

In an embodiment, the present invention provides a method, performed by a multi-cell/multicast coordination entity (MCE) in a communication system in which a plurality of member user equipments (UEs) can engage in group communication, which includes obtaining information about a supported multimedia broadcast/multicast service (MBMS) mechanism of a member UE of the plurality of member UEs. The obtained information is used to select a multimedia broadcast/multicast service (MBMS) mechanism for a base station (eNB). The selected MBMS mechanism is notified to an application server.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a mobile (cellular) telecommunication system in which a system architecture for GCSE_LTE is employed;

FIG. 2 illustrates downlink logical channel mapping in a system in which SC-PTM has been introduced;

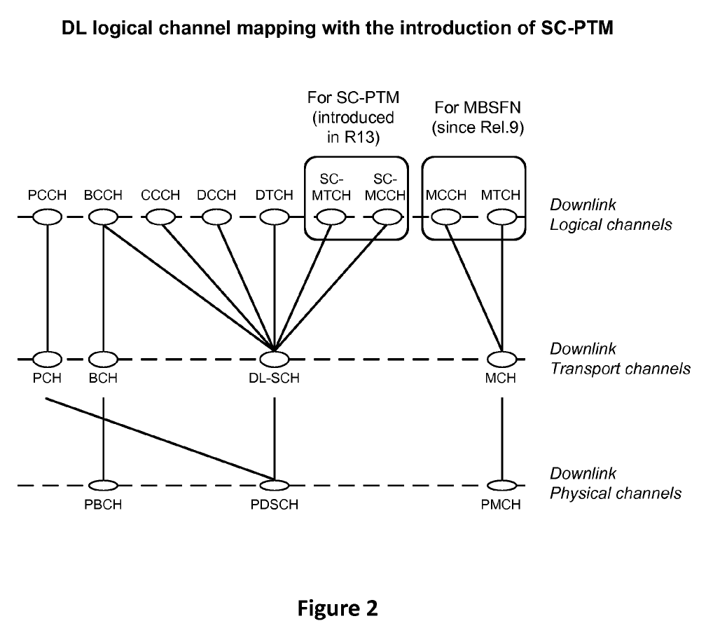

FIG. 3 illustrates an E-MBMS logical architecture;

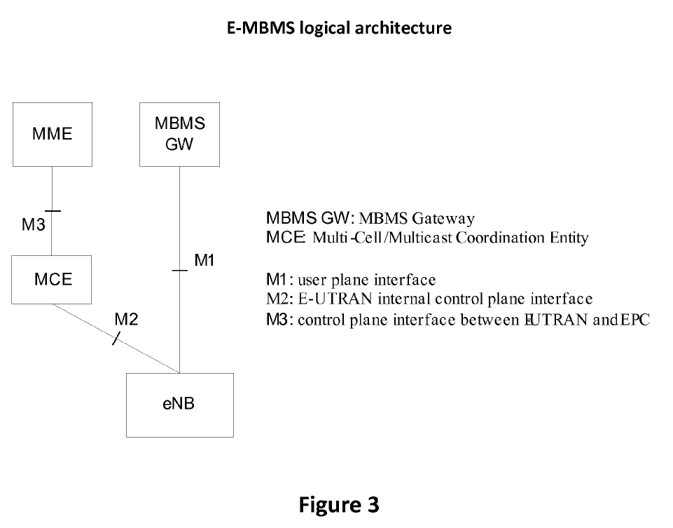

FIG. 4 illustrates a mobile (cellular) telecommunication system, in which an embodiment of the invention may be employed;

FIG. 5 is a simplified high level flowchart illustrating a possible procedure that may be employed by an MCE of FIG. 4 in the system of FIG. 4;

FIG. 6 is a simplified sequence diagram illustrating a possible implementation of a first step of FIG. 5 that may be employed in the system of FIG. 4;

FIG. 7 is a simplified sequence diagram illustrating a possible implementation of a second step of FIG. 5 that may be employed in the system of FIG. 4;

FIG. 8 is a simplified sequence diagram illustrating another possible implementation of a second step of FIG. 5 that may be employed in the system of FIG. 4;

FIG. 9 is a simplified sequence diagram illustrating another possible implementation of a third step of FIG. 5 that may be employed in the system of FIG. 4;

FIG. 10 is a simplified flow chart illustrating possible logic that may be used in an implementation of a fourth step of FIG. 5 in the system of FIG. 4;

FIG. 11 is a simplified sequence diagram illustrating a possible procedure, for an MCE to notify a result of the logic of FIG. 10 to a GCS-AS, in the system of FIG. 4;

FIG. 12 is simplified high level flowchart illustrating a possible procedure that may be employed by a GCS-AS in the system of FIG. 4;

FIG. 13 is a simplified sequence diagram illustrating a possible implementation of a first step of FIG. 12 that may be employed in the system of FIG. 4;

FIG. 14 is a simplified sequence diagram illustrating another possible implementation of a first step of FIG. 12 that may be employed in the system of FIG. 4;

FIG. 15 is a simplified flow chart illustrating possible logic that may be used in an implementation of a second step of FIG. 12 in the system of FIG. 4;

FIG. 16 is simplified high level flowchart illustrating a possible procedure that may be employed by communication apparatus in the system of FIG. 4;

FIG. 17 is a simplified sequence diagram illustrating two possible procedures for implementing a first step of FIG. 16 that may be employed in the system of FIG. 4;

FIG. 18 is a simplified sequence diagram illustrating a possible procedure for implementing a second and third step of FIG. 16 that may be employed in the system of FIG. 4;

FIG. 19 is an exemplary block diagram illustrating the main functionalities of a GCS-AS of the system shown in FIG. 4; and

FIG. 20 is an exemplary block diagram illustrating the main functionalities of an MCE of the system shown in FIG. 4.

### DETAILED DESCRIPTION

The inventors have recognized that there is a need for an improved communication system which address or at least partially ameliorate one or more of the above issues.

In considering this need, the inventors have realised that, depending on the scenario as described above, it would be beneficial for the GCS-AS to be able to dynamically adjust and switch the delivery between unicast and MBMS. More specifically, the inventors have realised that it would be advantageous to be able to dynamically adjust and switch the delivery between unicast and MBMS depending on:

1) UE's capability of SC-PTM,

2) the cell in which the UE is located, and/or

3) the MBMS mechanism used in that cell.

It will be appreciated that, from Public Safety's perspective, due to its nature of relatively well-defined closed community of users (e.g. police, fire department, other government agencies), the scenarios described above may not be an issue, for example if the relevant agency/agencies ensure that all public safety UEs support SC-PTM from day-1 meaning that the issue of UE support variation would never arise (including logistical aspects such as unused UE inventory). Nevertheless, it is likely that these features would also have benefits in a commercial service context depending on the possible commercial application(s). For example, a recent proposal in 3GPP indicates that SC-PTM will be the baseline feature for MTC and NB-IOT [8]. In this case, the mixture of different UE capabilities is expected to be a relevant issue if SC-PTM is deployed in the commercial environment.

The inventors have recognized that with the introduction of SC-PTM, specific UE support is useful due to the introduction of new logical channels (SC-MTCH, SC-MCCH) in the Uu interface. This implies that there can be a situation where a certain UE is capable of handling SC-PTM, while others are not capable of handling SC-PTM, depending on implementation. This further implies that there can be a situation where a mix of different UE implementations co-exists in the field. Based on this, the inventors have identified a number of key areas at which improvements in group communication methodologies may be directed.

Firstly, for example, there is the question of how to efficiently determine which of the two MBMS mechanisms is used for a given group communication, taking into account the UE capability (SC-PTM support) of the UEs in the group, including mixed capability scenarios, i.e. legacy UEs and UEs with SC-PTM support in the same cell coverage area.

Specifically, the MCE is responsible for selecting whether MBSFN or SC-PTM mechanism is used for a given group communication. However, the relevant necessary information, such as the UE's capability of SC-PTM and the population of group member UEs under the cell coverage, are not available. Selecting SC-PTM mechanism when SC-PTM non-supporting UE is present is a wrong choice but the MCE does not have the relevant information to make the right selection. Currently, according to the relevant 3GPP specification, the actual selection mechanism is implementation specific and thus outside the scope.

Secondly, there is the question of how to efficiently determine in the GCS-AS whether MBMS or unicast delivery is used for a group communication for a given UE taking into account that the GCS-AS is neither aware of which of the two MBMS delivery mechanisms the MCE has selected for a given group communication nor whether a given UE supports the SC-PTM feature or not.

Specifically, the GCS-AS is responsible for selecting whether MBMS or unicast delivery is used for a given UE. However, the relevant and necessary information, such as the MBMS delivery mechanism selected by the MCE for a given group communication and UE's support capability of newly introduced feature, are not available. Selecting MBMS delivery for a UE for a group communication when SC-PTM is used but the UE does not support it is clearly a wrong choice but the GCS-AS does not have the relevant information to make the right selection.

Thirdly, since the GCS-AS selects the delivery mechanism (MBMS or unicast) to a given UE in the group communication, there may be issues of delivery mechanism obsolescence as a result of the current position of the UE changing due to dynamic nature of UEs' mobility.

Specifically, when a group communication is initially started, the delivery mechanism (MBMS or unicast) for a given UE selected by the GCS-AS may become unsuitable and thus obsolete due to the dynamic nature of UE membership under the cell coverage due to UE's mobility, etc. However, there is no mechanism defined in 3GPP specifications to dynamically change the MBMS delivery mechanism to adjust to the environment.

Accordingly, preferred embodiments of the present invention aim to provide methods and apparatus which at least contribute to providing improvements in one or more of these areas.

In an embodiment of the invention there is provided a method performed by a multi-cell/multicast coordination entity (MCE) in a communication system in which member user equipments (UEs) can engage in group communication, the method comprising: obtaining a member UE's supported multimedia broadcast/multicast service (MBMS) mechanism; using the obtained information to select a multimedia broadcast/multicast service (MBMS) mechanism for a base station (eNB); and notifying the selected MBMS mechanism to an application server.

The obtaining of the member UE's supported MBMS mechanism may obtain the member UE's supported MBMS mechanism via the eNB. The member UE's supported MBMS mechanism may be forwarded by the eNB to the MCE after the eNB obtains the member UE's supported MBMS mechanism from the member UE. The obtaining of the member UE's supported MBMS mechanism may obtain the member UE's supported MBMS mechanism along with location information (e.g. a cell ID) for the member UE. The method may further comprise receiving a device identity reported by the UE. The application server may comprise at least a group communication system application server (GCS-AS). The obtained member UE's supported MBMS mechanism may be received as capability information from the eNB. The notifying the selected MBMS mechanism to an application server may comprise forwarding the selected MBMS mechanism to a mobility management entity (MME).

In an embodiment of the invention there is provided a method performed by an application server in a communication system in which member user equipments (UEs) can engage in group communication, the method comprising: receiving, from a multi-cell/multicast coordination entity (MCE), a multimedia broadcast/multicast service (MBMS) mechanism selected by the MCE; and using the MBMS mechanism selected by the MCE to determine a delivery method for communication to an individual UE in a group communication.

The delivery method may be determined from a choice of delivery methods comprising MBMS and unicast. the MBMS mechanism selected by the MCE may be notified to the application server by the MCE via a mobility management entity (MME), MBMS gateway (MBMS-GW), and a broadcast-multicast service center (BM-SC). The method may further comprise receiving a device identity reported by the UE. 13. The method may further comprise correlating the device identity with an application level identity. The correlating may further comprise correlating the device identity and application level identity with the individual UE's capability, and the individual UE's location.

In an embodiment of the invention there is provided a multi-cell/multicast coordination entity (MCE) for a communication system in which member user equipments (UEs) can engage in group communication, the MCE comprising: a processor and a transceiver wherein the processor is configured to: obtain a member UE's supported multimedia broadcast/multicast service (MBMS) mechanism; use the obtained information to select a multimedia broadcast/multicast service (MBMS) mechanism for a base station (eNB); and control the transceiver to notify the selected MBMS mechanism to an application server.

In an embodiment of the invention there is provided an application server for a communication system in which member user equipments (UEs) can engage in group communication, the application server comprising: a processor and a transceiver wherein the processor is configured to: receive, from a multi-cell/multicast coordination entity (MCE), a multimedia broadcast/multicast service (MBMS) mechanism selected by the MCE; and use the MBMS mechanism selected by the MCE to determine a delivery method for communication to an individual UE in a group communication.

Embodiments of the invention extend to corresponding systems, methods, and computer program products such as computer readable storage media having instructions stored thereon which are operable to program a programmable processor to carry out a method as described in the embodiments and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently (or in combination with) any other disclosed and/or illustrated features. In particular but without limitation the features of any of the claims dependent from a particular independent claim may be introduced into that independent claim in any combination or individually.

In the following description, the term “group member UE” is referring to a UE which is member of a specific group.

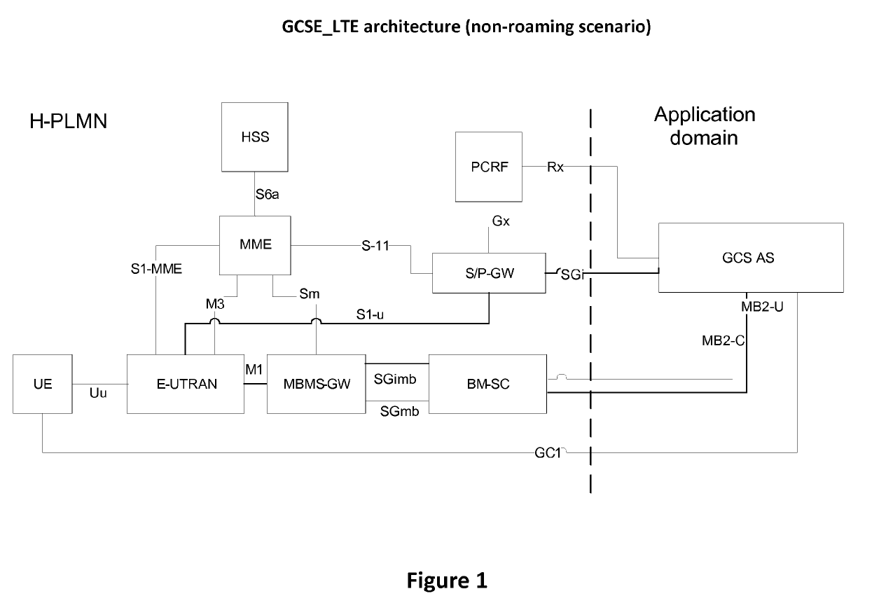

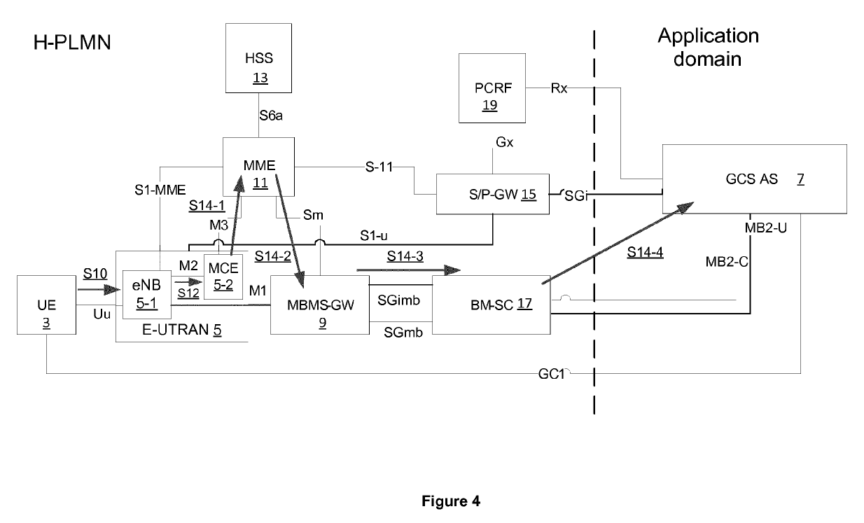

FIG. 4 schematically illustrates a mobile (cellular) telecommunication network 1, similar to that of FIG. 1, in accordance with a system architecture for GCSE_LTE (Group Communication System Enabler for Long Term Evolution (LTE)). In the telecommunication network 1, user equipment (UE) 3 can communicate with each other and other users via base stations (in this example eNBs 5-1) of a radio access network 5 (e.g. and Evolved Universal Terrestrial Radio Access Network—E-UTRAN) and a core network using an appropriate E-UTRA radio access technology (RAT). However, it will be appreciated that the radio access technology is not limited to E-UTRA, and may comprise any suitable access technology in accordance with one or more of the following standards: LTE, Universal Mobile Telecommunications System (UMTS), General Packet Radio Service (GPRS), Wi-Fi (IEEE 802.11 family of standards), Worldwide Interoperability for Microwave Access (WiMAX), and/or the like.

As described with reference to FIG. 1, a GC1 reference point is defined between the UE 3 and a GCS-AS 7 to allow the exchange of relevant information within the context of GCSE_LTE operation. Given that it is an application level interface between the UE 3 and the AS in the Application domain, this interface may be carried over the SGi interface in reality.

As seen in FIG. 4, in addition to a base station 5-1, the RAN 5 (i.e. the E-UTRAN in LTE) comprises an MCE (Multi-cell/multicast Coordination Entity) 5-2 which is responsible for selecting which of the two distribution mechanisms should be used for MBMS data.

The eNB 5-1 of the RAN 5 interfaces with an MBMS Gateway (MBMS GW) 9 via an M1 reference point for MBMS UP data delivery, and interfaces with an MCE 5-2 via an M2 reference point for MBMS Session Control (e.g. using the M2AP signalling protocol). The MCE 5-2 of the RAN 5 interfaces with a mobility management entity (MME) 11 via an M3 reference point for MBMS Session Control (e.g. using the M3AP signaling protocol). The MME 11 interfaces with an MBMS Gateway (MBMS GW) 9 via an Sm reference point for MBMS Session Control.

The MME 11 interfaces with an HSS 13 via an S6a interface (for exchange of data related to the location of the UE 3 and to the management of subscriber data) and with a Serving/PDN gateway (S/P-GW) 15 via an S11 interface (to support mobility and bearer management between the MME and S/P-GW). The MBMS GW 9 interfaces with a BM-SC 17 via a SGimb reference point (for MBMS data delivery) and a SGmb reference point (for MBMS signalling). The S/P-GW 15 interfaces with a policy and charging rules function (PCRF) 19 via a Gx reference point for the provisioning and removal of policy charging and control rules from the PCRF 19 to a policy and charging enforcement function (PCEF) in the S/P-GW and the transmission of traffic plane events from the PCEF to the PCRF 19.

The GCS AS 7 interfaces with S/P-GW 15 via the SGi interface for unicast UP data delivery, the BM-SC 17 via MB2-C and MB2-U reference points (for MBMS bearer service control and user plane signalling respectively), and with the PCRF 19 via an Rx reference point (for the transport of application level session information).

Beneficially, unlike other systems, the MCE 5-2 obtains a member UEs' 3 supported MBMS mechanism(s) via the eNB 5-1 (S10 to S12). This is done, beneficially, by the member UE 3 providing this information to the eNB 5-1 as shown at S10. After obtaining this information from the member UEs 3, the eNB 5-1 forwards it to the MCE 5-2 (possibly along with location information (e.g. a cell ID)) as shown at S12. The MCE 5-2 beneficially uses this information to determine the MBMS mechanism for the eNB 5-1.

The MCE 5-2 beneficially notifies the selected MBMS mechanism to the GCS AS 7 (e.g. via the MME 11, MBMS-GW 9, and BM-SC 17) as shown from S14-1 to S14-4. The MCE 5-2 may also beneficially notify information identifying the UE 3 (e.g. a UE ID) and its location (e.g. cell ID) to the GCS AS 7. Hence, the GCS AS 7 can use the received information to determine the delivery method (i.e. MBMS or unicast) for an individual UE 3 in the group communication.

In addition, the UE 3 may beneficially report its device identity to the AS 7 and the MCE 5-2 separately. This beneficially allows the GCS-AS 7 (or mission critical push-to-talk (MCPTT) application server which behaves as a GCS-AS 7) to correlate it with an application level identity (i.e. MCPTT ID).

Thus, the MCE 5-2 can determine the MBMS mechanism based on the interaction with the RAN entities 5-1, 5-2 and notify a selected MBMS mechanism to the GCS AS 7. The GCS AS 7 can thus obtain the necessary information to determine the delivery method (multicast or unicast) used in group communication for a given UE.

Thus the key areas discussed in the introduction above may be addressed, at least in part, by the above implementation. In particular, the implementation focuses on two key aspects: 1) a mechanism of the MCE to determine the MBMS mechanism for a group communication, 2) a mechanism of the GCS-AS to dynamically determine the delivery mechanism to a given UE in a group communication.

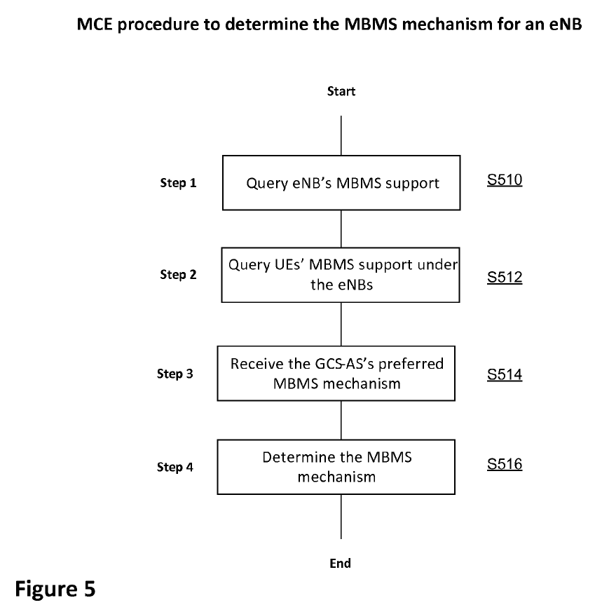

These mechanisms, and different possible approaches for implementing them, will now be described in more detail with reference to FIGS. 5 to 15.

### 1. Mechanism of the MCE to Determine the MBMS Mechanism for a Group Communication

FIG. 5 is a high level flowchart, from the perspective of the MCE 5-2, illustrating a possible mechanism employed by the MCE 5-2 to determine the MBMS mechanism for a group communication. The exact order of events in step 1 through 3 does not necessarily need to follow in the strict sequence shown. The key point is that the MCE receives the information before step 4.

As seen in FIG. 5, the mechanism includes of multiple steps:
1. The MCE 5-2 discovering, at S510, the associated eNB's 5-1 capability information with respect to the MBMS mechanism support: 1) MBSFN only, or 2) MBSFN+SC-PTM, or 3) SC-PTM only.
2. The MCE 5-2 discovering, at S512, the group member UEs' 3 capability information with respect to the MBMS mechanism support: 1) MBSFN only, or 2) MBSFN+SC-PTM, or 3) SC-PTM only.
3. (Optional) The MCE 5-1 receiving, at S514, the preferred MBMS mechanism from the GCS-AS: 1) MBSFN, or 2) SC-PTM.
4. The MCE 5-2 determining, at S516, the MBMS mechanism based on the information in step 1 and 3 above.

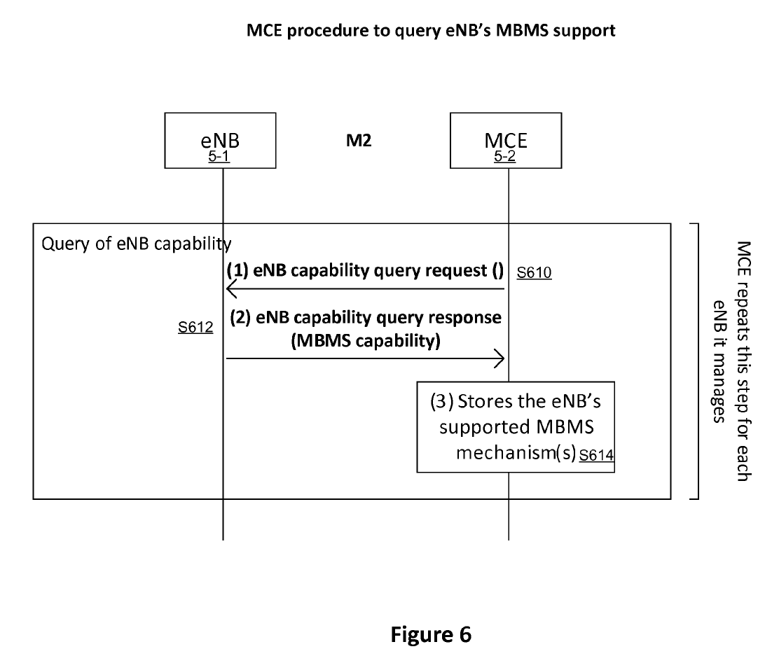

Step 1 (FIG. 5—S510): FIG. 6 is a simplified sequence diagram illustrating, in more detail, a possible implementation of step 1 of FIG. 5.

As seen in FIG. 6, the MCE 5-2 discovers the associated eNB's 5-1 capability information with respect to the MBMS mechanism as follows:
a) The MCE 5-2 queries, at S610, the eNB 5-1 to check which MBMS mechanism it supports.
b) The eNB 5-1 responds, at S612, with its supported mechanism: 1) MBSFN only, or 2) both MBSFN and SC-PTM.
c) The MCE 5-2 stores, at S614, this information.

Note: the above steps are repeated for all eNBs 5-1 the MCE 5-2 controls.

The message names shown in FIG. 6 are indicative and may not be currently defined in M2AP spec [7]. They can either be a newly defined message or new IE can be introduced to existing messages. Alternatively, the MCE 5-2 may be pre-configured with the eNB's 5-1 capability, for example, via O&M system.

As a result of this procedure, the MCE 5-2 will acquire mapping information between the eNB 5-1 and its supported MBMS mechanism, shown as follows as an example in Table 1.

TABLE 1
mapping information of eNB and its MBMS mechanism support

| eNB ID | eNB's MBMS support |
|---|---|
| 10 | MBSFN |
| 20 | MBSFN |
| 30 | MBSFN and SC-PTM |
| 40 | MBSFN and SC-PTM |

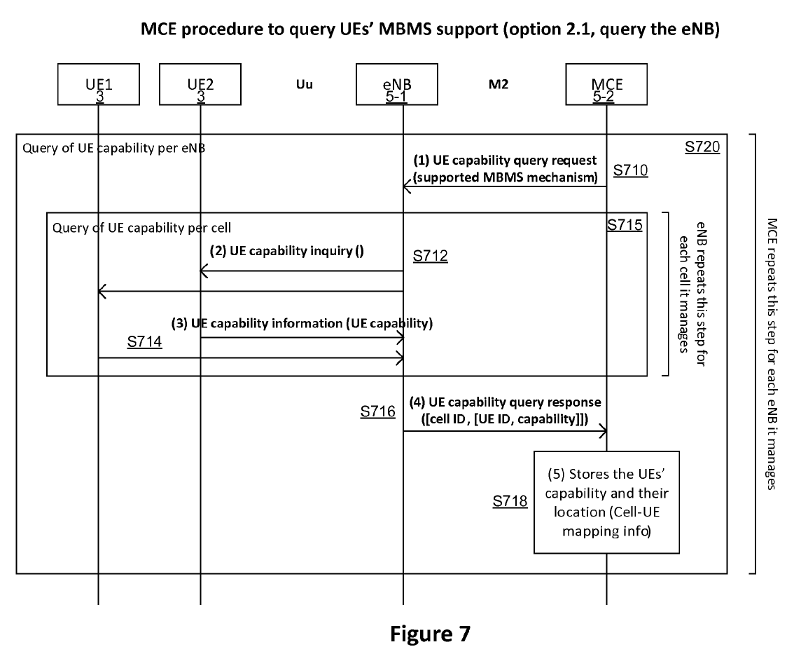

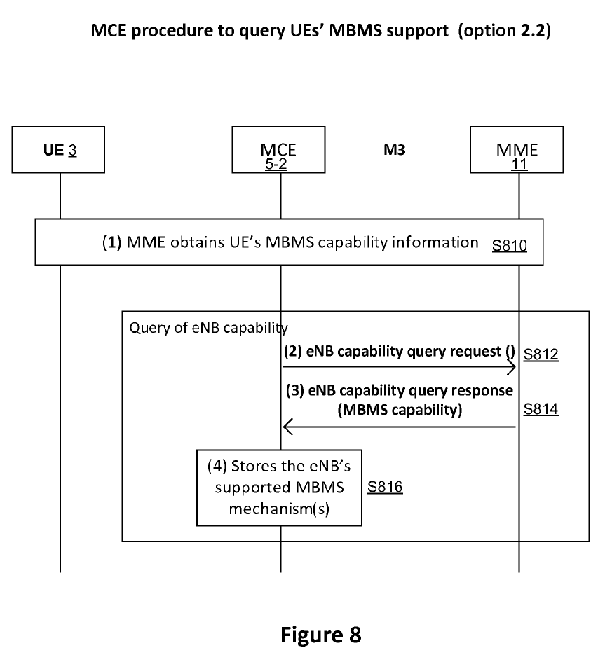

Step 2 (FIG. 5—S512): FIGS. 7 and 8 are simplified sequence diagrams illustrating, in more detail, possible implementations of step 2 of FIG. 5.

Specifically, as seen in FIGS. 7 and 8, the MCE 5-2 may discover the group member UEs' 3 capability information with respect to the MBMS mechanism support in either of the following ways.

In one option 2.1, shown in FIG. 7, the MCE 5-2 queries the eNB 5-1 about the UE's capability.
a) The MCE 5-2 requests, at S710, the eNB 5-1 to query the group member UE 3 which MBMS mechanism it supports.
b) The eNB 5-1 queries, at S712, the group member UE 3 which MBMS mechanism it supports.
c) The UE 3 responds, at S714, its supported mechanism: 1) MBSFN only, or 2) both MBSFN and SC-PTM.
d) The eNB 5-1 repeats step 2 and 3 for all member UEs 3 as indicated by box S715.
e) The eNB 5-1 consolidates, at S716, the information obtained in step 2 through 4 and reports it to the MCE 5-2.
f) The MCE 5-2 stores, at S718, this information.

Note: the above steps are repeated for all cells the eNB 5-1 controls as indicated by box S720.

This step is shown in FIG. 6. The message names shown in FIG. 7 between the eNB 5-1 and MCE 5-2 are indicative and may not be currently defined in M2AP spec [7]. They can either be a newly defined message or new IEs can be introduced to existing messages. For the message between UEs 3 and the eNB 5-1, for example, a new IE can be introduced and be added to existing RRC message.

In another option 2.2, shown in FIG. 8, the MME obtains and stores the UE's MBMS capability information (e.g. at S810) and the MCE 5-2 queries the MME 11 about the UE's 3 capability as follows:
a) The MCE 5-2 requests, at S812, the MME 11 to query the group member UE 3 which MBMS mechanism it supports.
b) The MME 5-2 reports, at S814, the MBMS mechanism that UE 3 supports, to the requesting MCE 5-2.
c) The MCE 5-2 stores this information at S816.

There are a number of possible mechanisms for the MME 11 to obtain the MBMS capability from the UE 3, for example as follows:
The UE 3 informs the MME 11 about its SC-PTM capability, for example, during:
   1) NAS attach and/or other mobility procedure(s); and/or
   2) during NAS signalling for the MBMS establishment procedure.
Then the MME 11 stores this information obtained from the UE 3 for use in responding to associated queries from an MCE 5-2.
The MME 11 requests, via an explicit NAS signalling exchange with the UE 3, to query the UE's 3 MBMS-related capability information whenever needed. For example, a new NAS session management (SM) procedure can be specified for UE capability exchange. Then the MME 11 stores this information obtained from the UE 3 for use in responding to associated queries from an MCE 5-2.

It will be appreciated that although the procedure of FIG. 8 shows the MME 11 obtaining the MBMS capability information from the UE 3 prior to the MCE 5-2 requesting the MME 11 to obtain the UE's MBMS capability, the MME 11 may obtain the MBMS capability information from the UE 3 in response to receiving a corresponding request from the MCE 5-2.

As a result of this procedure, the MCE 5-2 will acquire the mapping information between the cell and member UE(s) 3 under that cell and its/their supported MBMS mechanism, shown as follows as an example in Table 2.

TABLE 2
mapping information of Cell and its corresponding
UE and its MBMS mechanism support

| Cell ID | UE ID | UE's MBMS support |
|---|---|---|
| 101 | 1000 | MBSFN |
| 101 | 1001 | MBSFN and SC-PTM |
| 102 | 2000 | MBSFN |
| 103 | 3000 | MBSFN and SC-PTM |
| 103 | 3001 | MBSFN and SC-PTM |

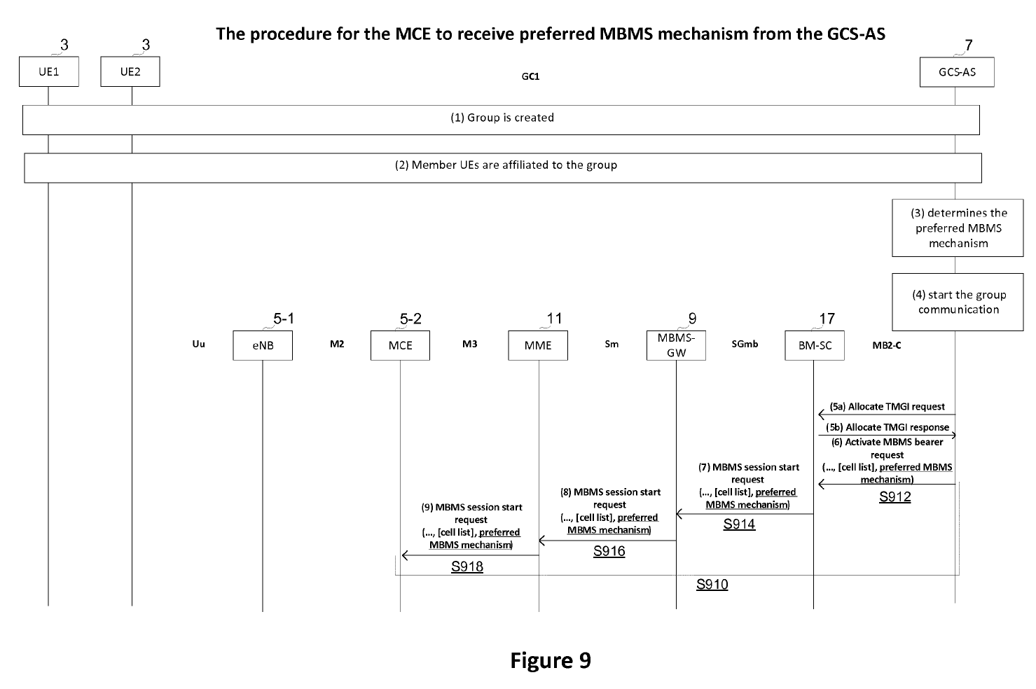

Step 3 (FIG. 5—S514): FIG. 9 is a simplified sequence diagram illustrating, in more detail, a possible implementation of step 3 of FIG. 5, in which the MCE 5-2 receives the preferred MBMS mechanism from the GCS-AS 7.

As seen in FIG. 9, the MCE 5-2 receives, as indicated at S910, the preferred MBMS mechanism, indicated by the GCS-AS 7. Specifically, at S912 the GCS-AS 7 provides the preferred MBMS mechanism to the BM-SC 17 (e.g. in an Activate MBMS bearer request). At S914 the BM-SC 17 sends the preferred MBMS mechanism to the MBMS-GW 9 (e.g. in an MBMS session start request). At S916 the MBMS-GW 9 forwards the preferred MBMS mechanism to the MME 11 (e.g. in the MBMS session start request). At S918 MME 11 forwards the preferred MBMS mechanism to the MCE 5-2 (e.g. in the MBMS session start request).

Thus, in addition to the information obtained in in step 1 and 2 described above), this step can provide additional information for the MCE 5-2 to take into account. In this respect, this step can be optional.

It will be understood that, whilst elements of the procedure for this step have been proposed in the past 3GPP meeting in S6-160893 [9], the part of the procedure described here in relation to one of the steps of FIG. 5, expands upon above and beyond what is discussed in [9].

Specifically, one enhancement is that the GCS-AS 7 provides in FIG. 9 step 6 (S912) to step 9 (S918) a cell list with the preferred MBMS mechanisms to the MCE 5-2. The GCS-AS 7 may also provide a list of user identities (SIP URI, IMSI, TMSI, MSISDN etc.) that are involved in the group communication and which can be understood by the MCE 5-2. The GCS-AS 7 may combine the cell list and the user identity list, i.e. listing the UE identities per cell. The MCE 5-2 uses the identities to determine the UE capabilities to take into account the MBMS delivery mechanism on a per UE basis or per cell basis.

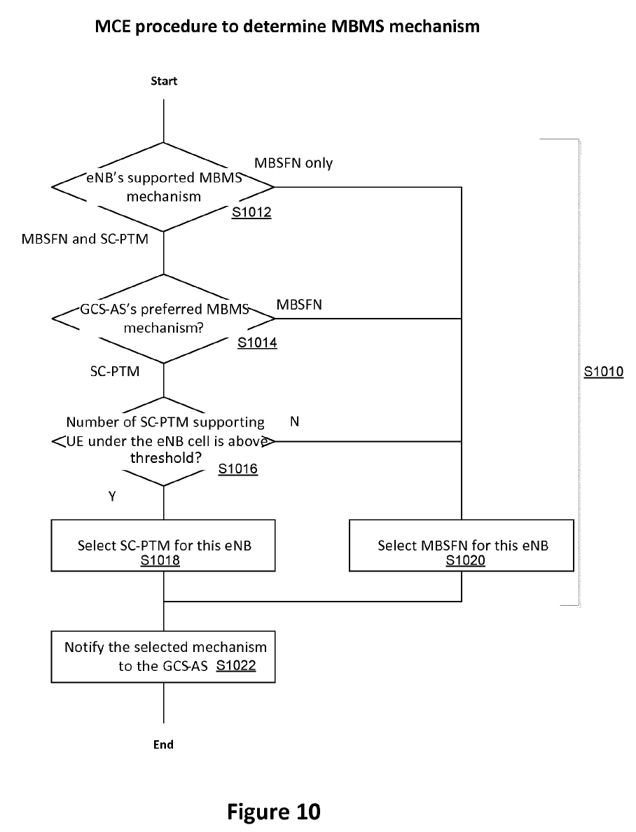

Step 4 (FIG. 5—S516): FIG. 10 is a simplified flow chart illustrating, in more detail, possible logic that may be used in and implementation of step 4 of FIG. 5 in which the MCE 5-2 determines the MBMS mechanism based on the information in Step 1, 2 and 3 above.

As seen in FIG. 10, the MCE 5-2 first determines which MBMS mechanism to select, based on the information obtained in FIG. 5 step 1, 2, and 3 described above, as shown at S1010. The MCE 5-1 then notifies the selected MBMS mechanism to the GCS-AS 7 at S1022.

It should be noted that the selected MBMS mechanism at eNB or cell level can be separate and independent for different multiple group communications.

FIG. 10 shows, between S1012 and 1020, logic that may be used by the MCE 5-2 to derive its decision at S1010.

As seen in FIG. 10, at S1012, the MCE 5-2 identifies the MBMS mechanism(s) supported by the eNB 5-1 (or associated cell(s)) serving the group member UEs 3 (e.g. based on the information acquired in step 1 of FIG. 5). If, at S1012, the MCE 5-2 identifies that the eNB 5-1 (or associated cell(s)) support SC-PTM then (optionally), at S1014, the MCE 5-2 identifies the preferred MBMS mechanism(s) of the GCS-AS 7 (e.g. based on the information acquired in step 3 of FIG. 5 if step 3 is implemented). If, at S1014, the MCE 5-2 identifies that the preferred mechanism of the GCS-AS 7 is SC-PTM then, at S1016 the MCE 5-2 identifies the number of SC-PTM supporting group member UEs 3 are operating in the cell(s) of the eNB 5-1. If, at S1016, the MCE 5-2 determines that the number of SC-PTM supporting group member UEs 3 operating in the cell(s) of the eNB 5-1 is greater than a particular threshold (or, alternatively, that all the group member UEs 3 operating in the cell(s) of the eNB 5-1 support SC-PTM) then the MCE 5-2 selects SC-PTM for that eNB 5-1. It will be appreciated that if SC-PTM is selected for an eNB 5-1 and not all UEs support SC-PTM then the group communication to the non-supporting UEs can be delivered by unicast.

On the other hand, at 51020, the MCE 5-2 selects MBSFN for the eNB 5-1, if the MCE 5-2 identifies: at S1012, that the eNB 5-1 (or associated cell(s)) do not support SC-PTM; at S1014, that the preferred mechanism of the GCS-AS 7 is SC-PTM then; or at S1016, that the number of SC-PTM supporting group member UEs 3 operating in the cell(s) of the eNB 5-1 is lower than a particular threshold (or, alternatively, that not all the group member UEs 3 operating in the cell(s) of the eNB 5-1 support SC-PTM).

It will be appreciated that whilst a specific exemplary logic is shown in FIG. 10 for illustrative purposes there may be variations on this logic (e.g. S1014 may not be present).

Key points to highlight in this regard are the following:
Generally speaking, if the eNB (cell(s)) support SC-PTM, and all group member UEs under the cell supports SC-PTM, then SC-PTM is the primary choice as the MBMS delivery mechanism. Nevertheless, MBSFN can also be an alternative choice based on other factors, such as when one or more of the adjacent cells already uses MBSFN to deliver MBMS. If there is no adjacent cell that uses MBSFN, then SC-PTM is likely a better choice.
Generally speaking, if the eNB (cell(s)) support SC-PTM, and there is at least 1 group member UE under the cell does not support SC-PTM, then MBSFN is the primary choice as the MBMS delivery mechanism in order to ensure the non-supporting UE can receive the MBMS. Nevertheless, as shown in FIG. 10, SC-PTM can be selected if the number of SC-PTM supporting UE is above a threshold, in which case, the group communication to other non-supporting UEs can be delivered by unicast. Such a threshold value may represent either specific number of UE or a percentage of the member population in a cell. The threshold can be pre-configured to the MCE by O&M system.
In both cases discussed above, the MCE can take the preference from the GCS-AS into account (as shown in FIG. 10) to determine the selection between the two MBMS mechanisms. Upon taking this information into account, the MCE tries to honor the preference of the GCS-AS identified by the MCE. However, if the MCE identifies a preference of SC-PTM and there are non-supporting UEs, it implies that unicast delivery may need to be done for those non-supporting UEs. This implies more dedicated radio resource is required and thus not efficient. In such case, the MCE may override the GCS-AS's preference and select MBSFN instead.

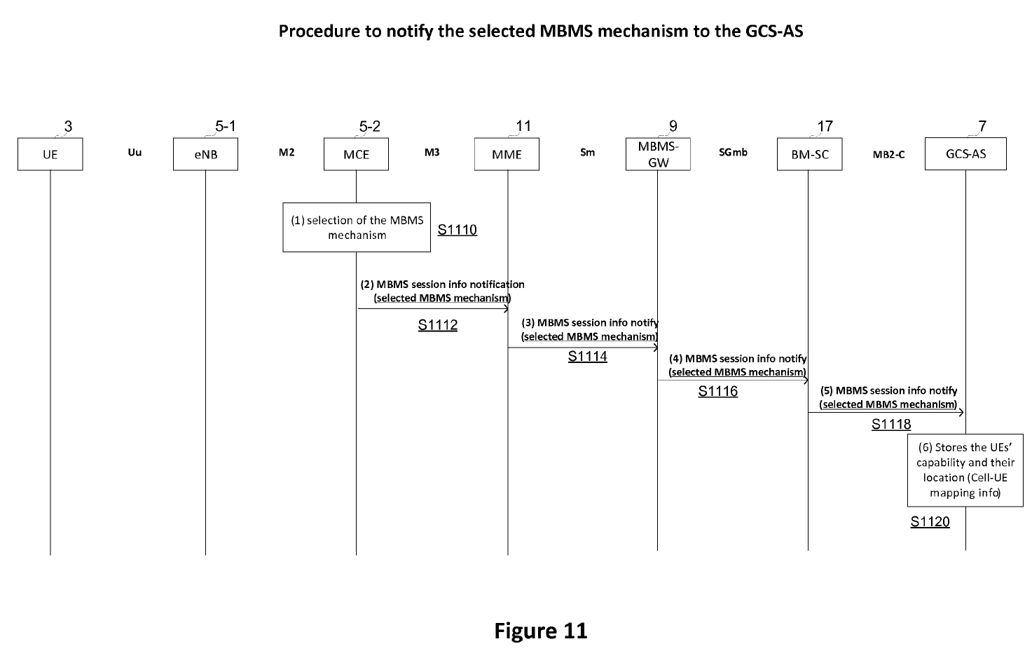

FIG. 11 shows a procedure for the MCE 5-2 to notify the selected MBMS mechanism to the GCS-AS 7 (e.g. corresponding to S1022 of FIG. 10). In FIG. 11, the underlined text indicates the new IE to convey this information to the GCS-AS 7.

As seen in FIG. 11, following selection of an MBMS mechanism at S1110 (e.g. corresponding to the steps referred to collectively at S1010 in FIG. 10), the MCE 5-2 sends, at S1112, an information element identifying the selected MBMS mechanism to the MME 11 (in this example in an MBMS session information notification message). The MME 11 forwards, at S1114, the information element identifying the selected MBMS mechanism to the MBMS-GW 9 (in this example in an MBMS session information notify message). The MBMS-GW 9 forwards, at S1116, the information element identifying the selected MBMS mechanism to the BM-SC 17 (in this example in an MBMS session information notify message). The BM-SC 17 forwards, at S1118, the information element identifying the selected MBMS mechanism to the GCS-AS 7 (in this example in an MBMS session information notify message). The GCS-AS 7 stores the MBMS capability information for each of group member UE, in association with the location (e.g. as Cell-UE mapping information).

It will be appreciated that, the message names shown in FIG. 11 are indicative and may not be currently defined in the relevant specs. The protocol between the MCE 5-2 and the MME 11 may be M3AP but could be any suitable protocol to convey the new IE. Alternatively, this new IE can be added to an existing message in the specification, e.g. response message for the MBMS session start request sent by the GCS-AS 7 to the MCE.

As an alternative method, the eNB 5-1 may broadcast information regarding the MBMS mechanism it supports over the System Information Block (SIB). This information contains indication such as which of the two MBMS mechanisms the cell supports (e.g. MBSFN only, or both MBSFN and SC-PTM or SC-PTM only). The UE 3 under the cell coverage area can obtain this information and match it against its own MBMS capability. The UE 3 can then indicate to the GCS-AS 7 the supported and/or preferred MBMS transmission mechanism.

Alternatively the UE 3 can inform the eNB 5-1 whether or not the UE 3 can use this cell for receiving the group communication over MBMS. The eNB 5-1 collects this information from all member UEs 3 under the cell, and indicates this information to the MCE 5-2. The MCE 5-2 can then determine which of the two MBMS mechanisms should be used for this cell.

### 2. Mechanism of the GCS-AS to Dynamically Determine the Delivery Mechanism to a Given UE in a Group Communication

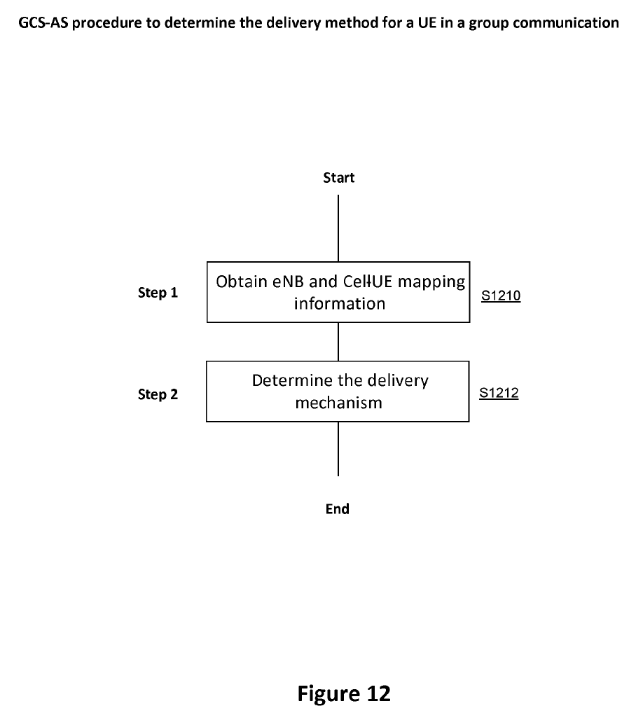

FIG. 12 is high level flowchart, from the perspective of a GCS-AS 7, of a mechanism for the GCS-AS 7 to dynamically determine the delivery mechanism to a given UE 3 in a group communication.

As seen in FIG. 12, this mechanism includes of the following steps:
a) The MCE 5-2 to provide the eNB information of MBMS mechanism support and the Cell-UE mapping information to the GCS-AS 7. Thus, the GCS-AS 7 obtains, at S1210, the eNB information and the Cell-UE mapping information as seen in FIG. 12.
b) The GCS-AS 7 determines, at S1212, the delivery mechanism to a UE 3 whether to keep the current delivery mechanism, to switch from MBMS to unicast, or to switch from unicast to MBMS.

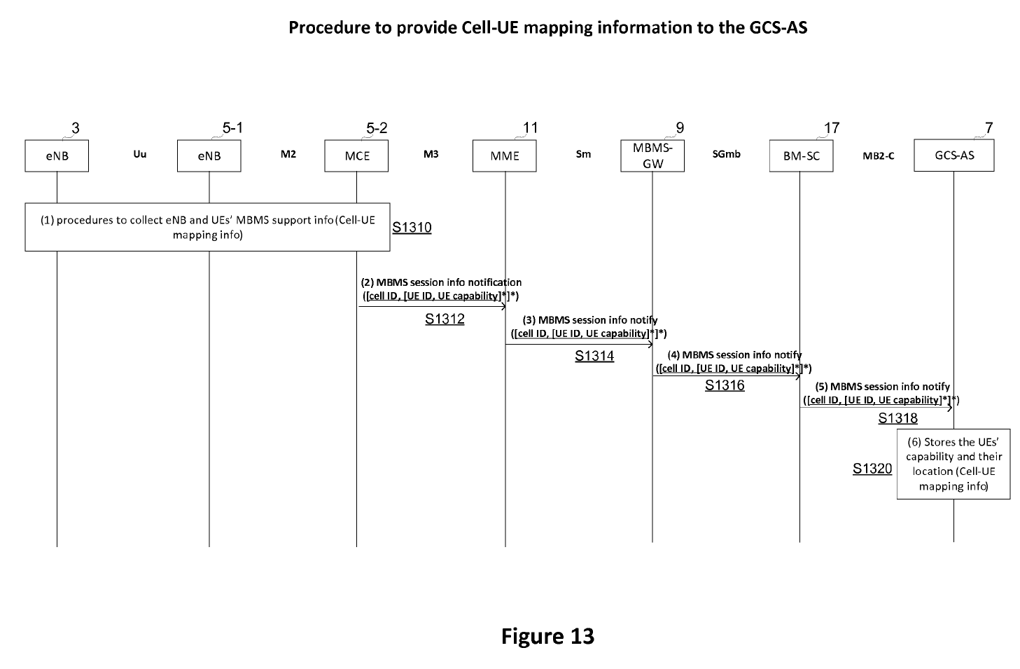

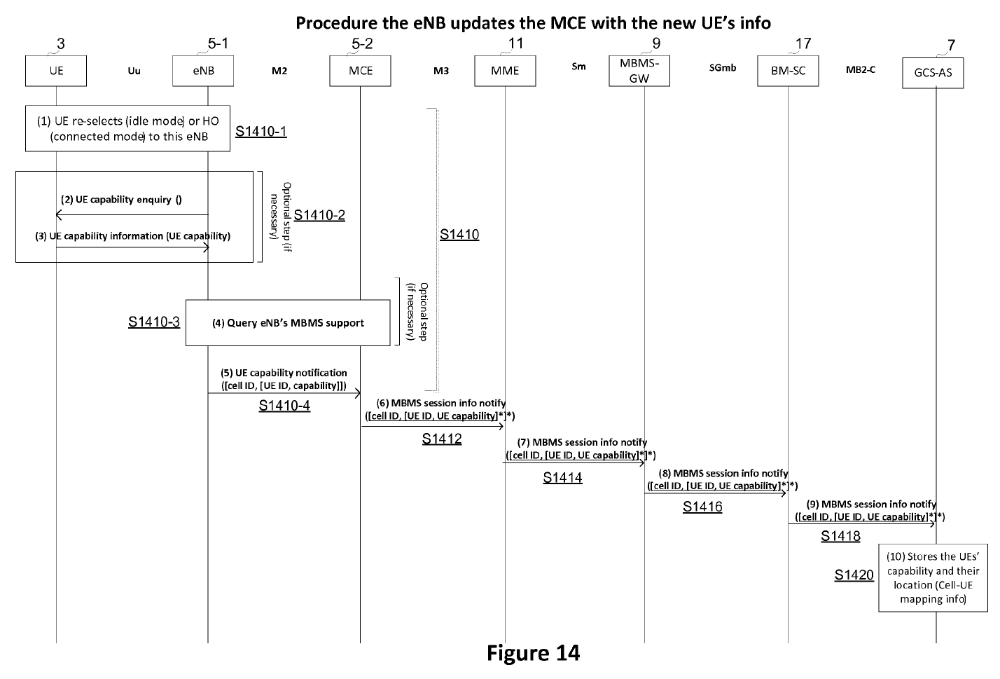

Step 1 (FIG. 12): FIGS. 13 and 14 are simplified sequence diagrams that illustrate possible implementations of step 1 of FIG. 12 in in more detail.

As seen in FIG. 13, the MCE 5-2 provides the eNB information of MBMS mechanism support and Cell-UE mapping information to the GCS-AS 7 as follows:
a) The MCE 5-2 discovers, at S1310, the associated eNB's capability information with respect to the MBMS mechanism, and the group member UE's capability information with respect to the MBMS mechanism support (this is the procedure as described with respect to steps 1 and 2 of FIG. 5 in the previous section).
b) The MCE 5-2 provides the Cell-UE mapping information and optionally the UE's MBMS support (e.g. cell ID, UE ID, UE capability) to the GCS-AS 7 from S1312 to S1318. Specifically, the MCE 5-2 sends, at S1312, the Cell-UE mapping information to the MME 11 (in this example in an MBMS session information notification message). The MME 11 forwards, at S1314, the Cell-UE mapping information to the MBMS-GW 9 (in this example in an MBMS session information notify message). The MBMS-GW 9 forwards, at S1316, the Cell-UE mapping information to the BM-SC 17 (in this example in an MBMS session information notify message). The BM-SC 17 forwards, at S1318, the Cell-UE mapping information to the GCS-AS 7 (in this example in an MBMS session information notify message).
c) The GCS-AS 7 stores this information at S1320.

When the Cell-UE association changed due to UE's mobility (e.g. reselection of another cell [idle mode mobility] or handover to another cell [connected mode mobility]), the eNB 5-1 updates the new Cell-UE mapping information to the MCE 5-2, and the MCE 5-2 updates this information to the GCS-AS 7. In this case, if the UE moves from one eNB 5-1 to another and the MCE 5-2 does not have the target eNB's MBMS support, then the MCE 5-2 may, optionally, query this information to the target eNB 5-1. If, on the other hand, the MCE 5-2 already has the target eNB's MBMS support, then the MCE 5-2 is not required to query this eNB 5-1. This query procedure may be the same as the one shown and described with reference to step 1 of FIG. 5 in the previous section. This procedure is shown in FIG. 14.

FIG. 14, is similar to that of FIG. 13 with S1410 to S1420 of FIG. 14 generally corresponding to S1310 to S1320 of FIG. 13. However, FIG. 14 illustrates in more detail, at S1410, one possible way in which the MCE 5-2 may discover the associated eNB's capability information with respect to the MBMS mechanism, and the group member UE's capability information with respect to the MBMS mechanism support. Specifically, in FIG. 14, when the UE reselects (in idle mode) or performs a handover (in connected mode) to a cell of a specific eNB 5-1 (e.g. at S1410-1), the eNB 5-1 may (if necessary) obtain, at S1410-2, the UE capability by sending a UE capability enquiry to the UE 3 and receiving the UE's capability in response (e.g. in a UE capability information message). The MCE 5-2 may (if necessary) obtain, at S1410-3, the eNB's MBMS support using a similar query procedure. The eNB 5-1 may provide, at S1410-4, the Cell-UE mapping information and optionally the UE's MBMS support (e.g. cell ID, UE ID, UE capability) to the MCE 5-2 (e.g. in a UE capability notification message).

It will be appreciated that, the message names shown in FIGS. 13 and 14 are indicative and may not be currently defined in the relevant specs. They can either be a newly defined message or new IE can be introduced to existing messages.

Note: an idea to introduce a new IE in these messages has already been proposed in the past 3GPP meeting in S6-160894 [10]. However, it proposes to add a different IE for a different purpose from this document. In that sense, this document expands what is proposed in [10].

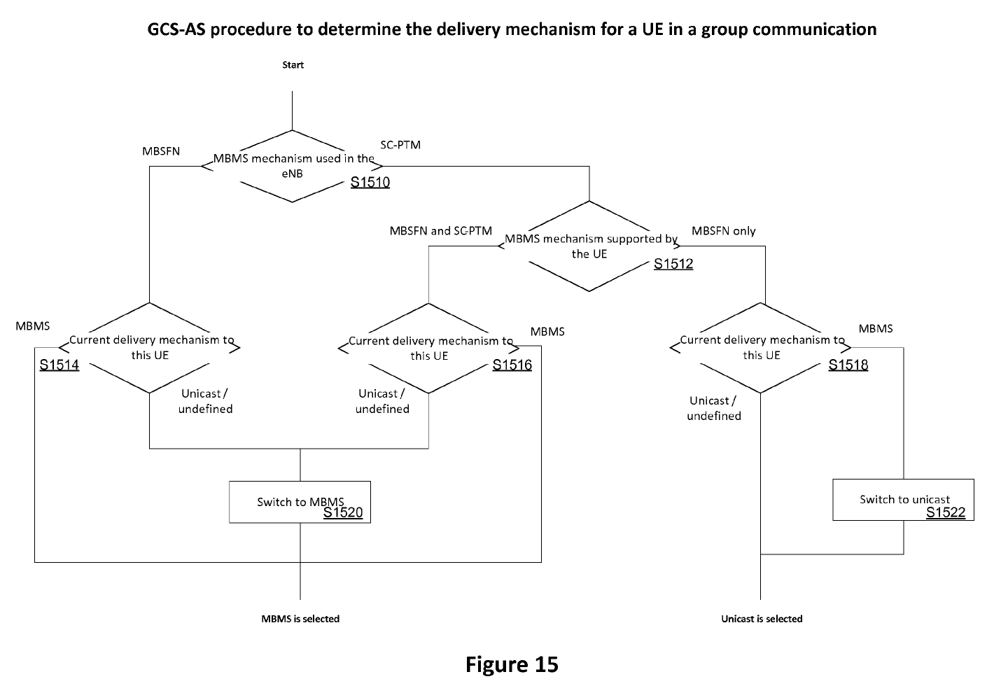

Step 2 (FIG. 12): FIG. 15 is a simplified flowchart which shows, in more detail, the logic in the GCS-AS 7 when the GCS-AS 7 determines the delivery mechanism to the UE based on the information in step 1 of FIG. 12 above.

As seen in FIG. 15, for a given UE 3, the GCSE-AS 7 identifies, at S1510, the MBMS mechanism used by the eNB 5-1 serving the given UE 3. If, at S1510, the GCSE-AS 7 identifies that the eNB 5-1 uses SC-PTM then, at S1512, the GCSE-AS 7 identifies the MBMS mechanism(s) supported by the UE 3. If, on the other hand the GCSE-AS 7 identifies, at S1510, that the eNB 5-1 (or associated cell(s)) use MBSFN then the GCSE-AS 7 identifies, at S1514, the current delivery mechanism being used for a given UE 3.

If the GCSE-AS 7 identifies at S1512, that both MBSFN and SC-PTM are supported by the UE 3, then the GCSE-AS 7 identifies, at S1516, the current delivery mechanism being used for the given UE 3. Similarly, if the GCSE-AS 7 identifies at S1512, that only MBSFN is supported by the UE 3, then the GCSE-AS 7 identifies, at S1518, the current delivery mechanism being used for the given UE 3.

If the MBMS mechanism used by the eNB 5-1 is MBSFN and the current delivery mechanism to the UE identified at S1514 is unicast or undefined, then the GCSE-AS 7 determines, at S1520, that the delivery mechanism should be switched to MBMS and MBMS is selected. Otherwise, if the MBMS mechanism used by the eNB 5-1 is MBSFN and the current delivery mechanism identified at S1514 is MBMS, then the GCSE-AS 7 determines that the delivery mechanism should remain unchanged and MBMS is selected.

If the MBMS mechanism used by the eNB 5-1 is SC-PTM, the given UE 3 supports SC-PTM and MBSFN, and the current delivery mechanism to the UE identified at S1516 is unicast or undefined, then the GCSE-AS 7 determines, at S1520, that the delivery mechanism should be switched to MBMS and MBMS is selected. Otherwise, the MBMS mechanism used by the eNB 5-1 is SC-PTM, the given UE 3 supports SC-PTM and MBSFN, and the current delivery mechanism identified at S1516 is MBMS, then the GCSE-AS 7 determines that the delivery mechanism should remain unchanged and MBMS is selected.

If the MBMS mechanism used by the eNB 5-1 is SC-PTM, the given UE 3 only supports MBSFN, and the current delivery mechanism identified at S1518 is MBMS, then the GCSE-AS 7 determines, at 51522, that the delivery mechanism should be switched to unicast and unicast is selected. Otherwise, the MBMS mechanism used by the eNB 5-1 is SC-PTM, the given UE 3 only supports MBSFN, and the current delivery mechanism identified at S1518 is unicast (or undefined), then the GCSE-AS 7 determines that the delivery mechanism should remain (or set to) unicast and unicast is selected.

It will be appreciated that whilst a specific exemplary logic is shown in FIG. 15 for illustrative purposes there may be variations on this logic.

The key points to highlight are the following:
Generally speaking, if the UE 3 is under the cell that delivers group message using SC-PTM, and the UE is not capable of SC-PTM, then the delivery to this UE 3 can be changed to unicast.
If the UE 3 is under the cell that delivers group message using SC-PTM, and the UE 3 is capable of SC-PTM, then the delivery to this UE should be MBMS (because if unicast is used, it's an extra waste of radio resource).
If the UE 3 is under the cell that delivers group message using MBSFN, then the delivery to this UE 3 should be MBMS (because if unicast is used, it's an extra waste of radio resource).

It will be understood that, in FIG. 15, the “undefined” case is for the situation, for example, where a member UE newly joins a group communication and the GCS-AS 7 has not yet determined the delivery mechanism for it. There may be other circumstances where the current delivery mechanism to the UE 3 is undefined.

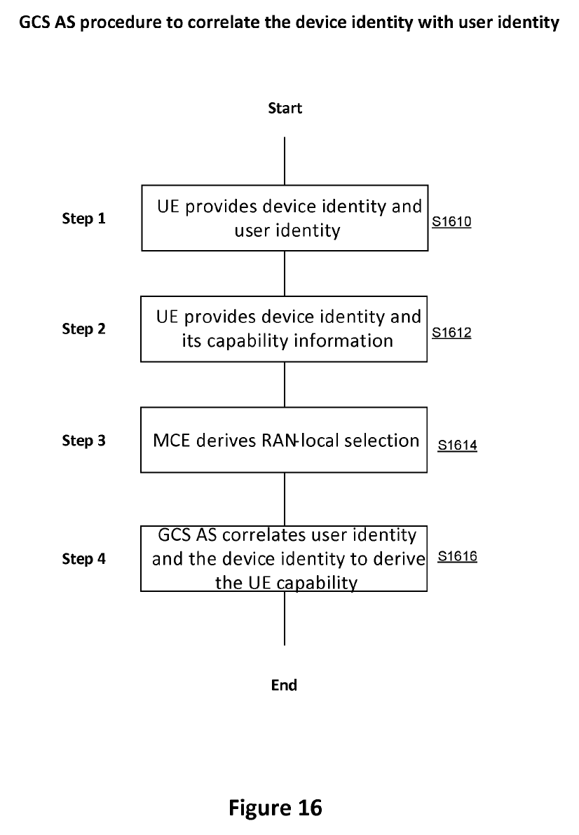

It will be appreciated that there are other possible approaches to those described with reference to FIGS. 5 to 15. One such approach is illustrated in FIGS. 16 to 18.

3 Mechanism of the GCS-AS to Correlate the User Identity with the Device Identity

FIG. 16 is high level flowchart illustrating a mechanism in which the GCS-AS 7 correlates the user identity with the device identity. This solution covers an supplemental procedure to what is described in solution 1 described earlier.

This mechanism typically comprises the following steps:
1. The UE 3 provides, as S1610, the UE's device identity along with the user identity to the GCS AS 7.
2. The UE 3 provides, at S1612, the UE's device identity and its capability information to the MCE 5-2.
3. The MCE 5-2 derives, at 51614, a RAN-location selection and forwards the mapping information to the GCS AS 7.
4. The GCS AS 7 correlates the user identity with the device identity to derive the corresponding UE's capability information.

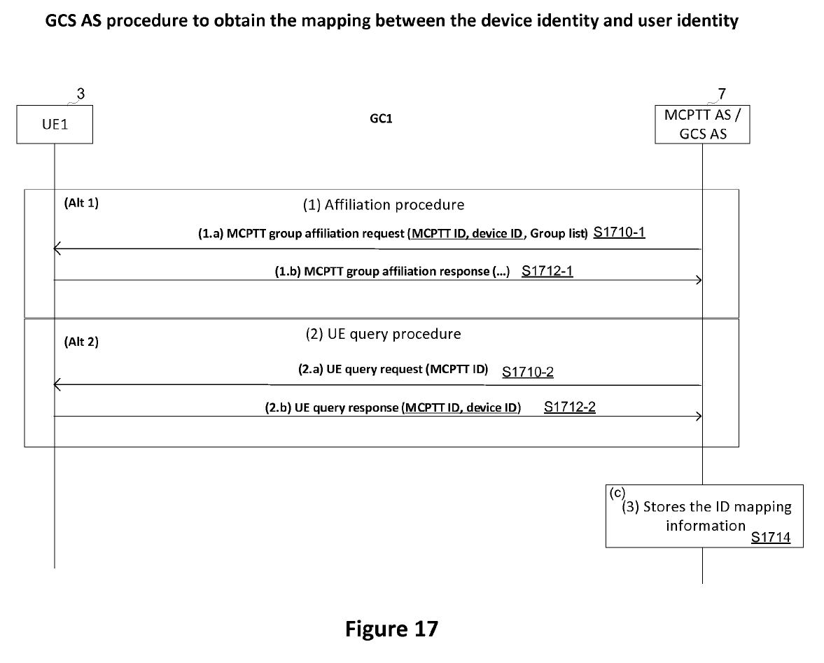

Step 1 (FIG. 16): FIG. 17 is a simplified sequence diagram illustrating two possible procedures in which the UE 3 provides its device identity and the user identity to the GCS AS 7 (which in this example may be a mission critical push-to-talk (MCPTT) application server which behaves as a GCS-AS 7).

As seen in FIG. 17, in both procedures there are the following steps:
a) Some form of request is sent by the GCS-AS 7 to the UE3 (e.g. at S1710-1 or S1710-2).
b) The UE 3 sends (e.g. at S1712-1 or S1712-2) an appropriate response to the request including its device identity and the user identity to the GCS AS 7.
c) The GCS AS 7 stores this as mapping information at S1714.

In this figure, steps a) and b) are represented in 2 alternate procedures. The messages in alternate procedure 1 comprise an MCPTT group affiliation request (including a user identity in the form of an MCPTT ID, a device ID, and a group list) and a MCPTT group affiliation response (including the user identity and device identity) and are defined in [12]. The messages in the alternate procedure 2 comprise a UE query request (including a user identity in the form of an MCPTT ID) and a UE query response (including the user identity and device identity) and are newly defined. Alternately, in either procedure, either new IE(s) may be defined in existing message(s), or new message(s) may be created to convey this information.

With the procedure of FIG. 17, the GCS AS 7 thus becomes aware of the mapping between the device identity and the user identity. The device identity refers to the UE 3 as the device and may be permanent information such as International Mobile Subscriber Identity (IMSI) or International Mobile Equipment Identity (IMEI), or temporary identity such as SAE-Temporary Mobile Subscriber Identity (S-TMSI) as defined in [11]. The user identity refers to the human user for the purpose of communication, and may be an identity specific to the application or service, such as MCPTT ID as defined in [12].

It will be understood that in FIG. 17, MCPTT AS and GCS AS 7 are shown as a single entity as the former may include the latter functionality per the architectural definition in [12]. It should be noted that there may be other mission critical (MC) service applications in addition to push-to-talk (PTT) service, such as video and data services. In this case, the respective application server (AS) for the service provided may include the GCS AS functionality.

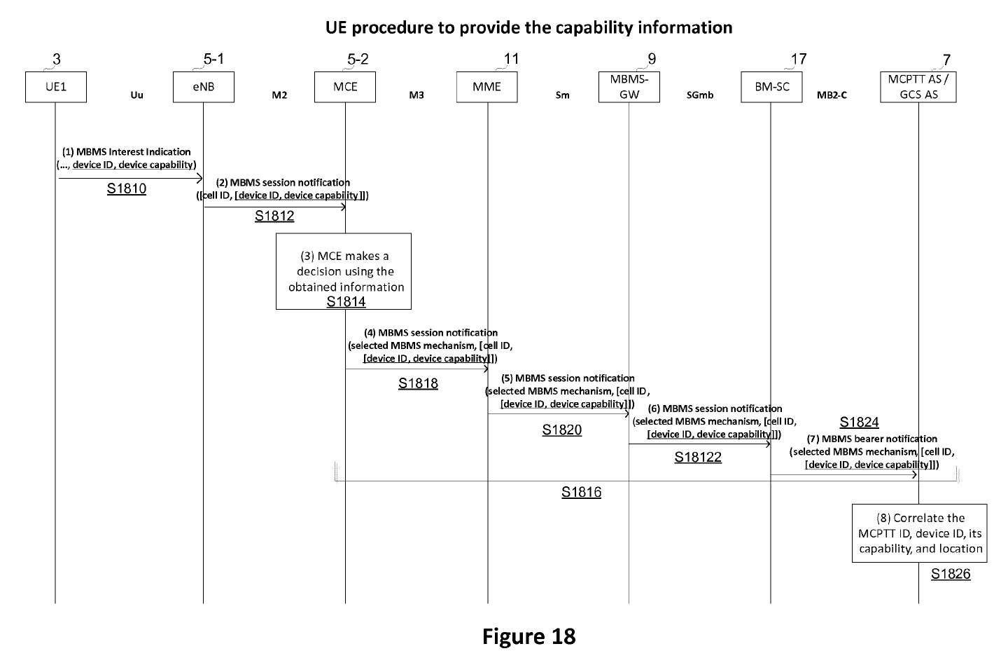

Step 2, 3 (FIG. 16): FIG. 18 is a simplified sequence diagram illustrating a possible procedure, for steps 2 and 3 of FIG. 16, in which the UE 3 provides its device identity and its capability information to the MCE 5-2, and the MCE 5-2 derives a selection local to the RAN.

As seen in FIG. 12, this procedure includes of the following steps:
a) The UE 3 sends, at S1810, its device identity and its capability information to the eNB 5-1 (e.g. using an MBMS Interest Indication message).
b) The eNB 5-1 forwards, at S1812, the mapping information (e.g. cell ID, UE ID, UE capability) to the MCE 5-2 (e.g. using an MBMS session notification message).
c) The MCE 5-2 uses, at S1814, this information to derive a selection local to the RAN.
d) The MCE 5-2 forwards, at S1816, this information to the GCS AS 7.

The GCS-AS 7 can then correlate, at S1826, the user identity with the device identity to derive the corresponding UE's capability information.

Thus, with this procedure the MCE 5-2 obtains the UE's device identity and its capability information. With this information, the MCE 5-2 derives a RAN-local selection. The type of decision may include the MBMS mechanism to be used in the eNB based on the UE's capabilities (MBSFN or SC-PTM). This decision involves aggregating information from multiple UEs 3 under the eNB's 5-1 cell coverage area. In other words, the MCE 5-2 makes a selection by taking the multiple UEs 3 capabilities into account upon selecting the MBMS mechanism for the eNB 5-1 to use.

The UE 3 sends its device identity and its capability information in the MBMS interest indication message at S1810. Upon receiving this message, the eNB 5-2 forwards it to the MCE in MBMS session notification message at S1812. In the first message, this information is added to the existing message defined in [13]. The second message is, however, newly defined. Alternately, in either message, either new IE may be defined in existing message or new message may be created to convey this information. In addition to this information, UE's location information may also be conveyed, such as cell ID where the UE is located.

It will be appreciated that the MCE 5-2 may receive this information from multiple UEs 3 under the same eNB 5-1. Based on this received information, the MCE 5-2 derives a selection such as the MBMS mechanism to be used in the eNB 5-1. The MCE 5-2 then forwards the mapping information of UE's 3 device identity, its capability information, and its location information toward the GCS AS 7 through the intermediate network elements as shown in the figure. Specifically, the MCE 5-2 sends, at S1818, the selected MBMS mechanism along with the Cell-UE mapping information to the MME 11 (in this example in an MBMS session notification message). The MME 11 forwards, at S1820, the selected MBMS mechanism along with the Cell-UE mapping information to the MBMS-GW 9 (in this example in an MBMS session notification message). The MBMS-GW 9 forwards, at S1822, the selected MBMS mechanism along with the Cell-UE mapping information to the BM-SC 17 (in this example in an MBMS session notification message). The BM-SC 17 forwards, at S1824, the selected MBMS mechanism along with the Cell-UE mapping information to the GCS-AS 7 (in this example in an MBMS session bearer notification message).

The GCS AS 7 receives this mapping information and stores it.

Step 4 (FIG. 16): The step in which the GCS AS 7 correlates the user identity with the device identity to derive the UE's capability information will now be discussed further.

In this step, the GCS AS 7 correlates the information that was obtained in previous steps. The MCE 5-2 uses the device identity as a key to correlate the user identity with the corresponding device's capability information.

It will be appreciated that the terminology for the used network functions is based on LTE/EPC (known or references as “4G”) specification in 3GPP. The mechanisms proposed in this document can be applicable to similar network functions which can be part of a 5G communication system or any other communication networks. For example, a MME 11 can be in general a serving node implementing mobility management and registration functionality in any other communication system, and/or MCE 5-2 can be a network function as part of an access network or core network managing the multicast/broadcast communication.

### GCS-AS (Group Communication System Application Server)

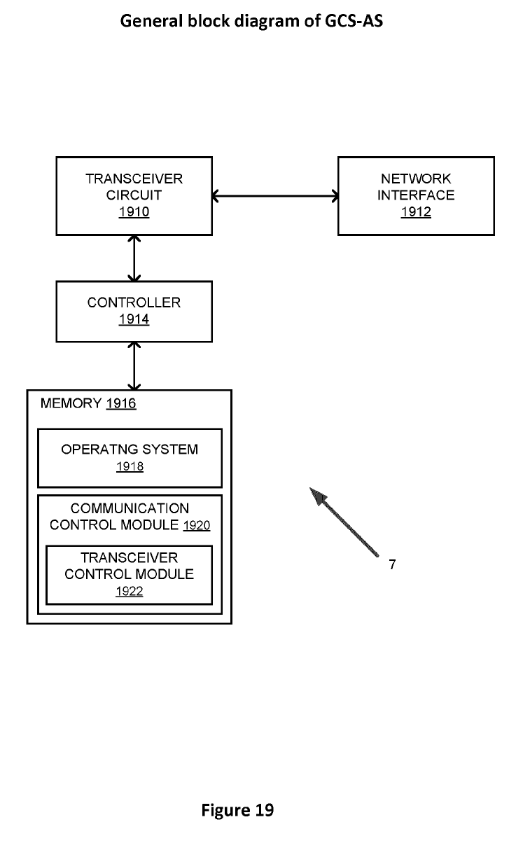

FIG. 19 is a block diagram illustrating the main components of the GCS-AS 7. As shown, the GCS-AS 7 includes transceiver circuit 1910 which is operable to transmit signals to and to receive signals from the connected node(s) via a network reference point (e.g. MB2-U, MB2-C, etc.) 1912. A controller 1914 controls the operation of the transceiver circuit 1910 in accordance with software stored in a memory 1916. The software includes, among other things, an operating system 1918 and a communications control module 1920 having at least a transceiver control module 1922. The communications control module 1922 is operable to retrieve messages to/from BM-SC 17 over MB2-C and MB2-U, or to/from UE 3 over GC1 interface. The communications control module 1922 is operable to control the generation of signaling messages based on different protocols via different nodes (e.g. BM-SC). The communications control module 1922 is responsible for signaling the request and for receiving messages with these nodes. The memory module 1916 is operable to store the group member UEs' MBMS support capability information and its cell it is associated with, and associated eNB's MBMS support capability information.

### MCE (Multi-Cell/Multicast Coordination Entity)

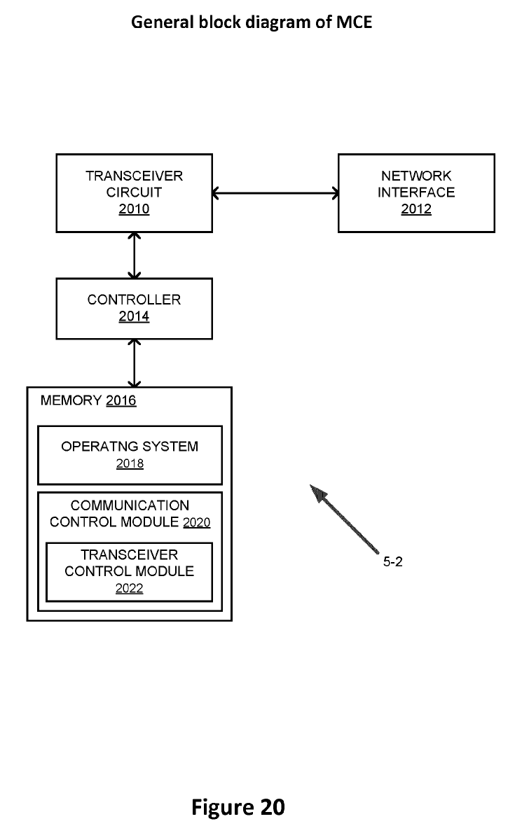

FIG. 20 is a block diagram illustrating the main components of the MCE 5-2. As shown, the MCE 5-2 includes transceiver circuit 2010 which is operable to transmit signals to and to receive signals from the connected node(s) via a network reference point (e.g. M2, M3, etc.) 2012. A controller 2014 controls the operation of the transceiver circuit 2010 in accordance with software stored in a memory 2016. The software includes, among other things, an operating system 2018 and a communications control module 2020 having at least a transceiver control module 2022. The communications control module 2020 is operable to retrieve messages to/from eNB 5-1 over M2, to/from MME over MM3. The communications control module 2020 is operable to control the generation of signaling messages based on different protocols via different nodes (e.g. eNB 5-1, MME 11, MBMS GW 9). The communications control module is responsible for signaling the request and for receiving messages with these nodes. The memory module 2016 is operable to store the group member UEs' MBMS support capability information and its cell it is associated with, and associated eNB's MBMS support capability information.

The above described exemplary embodiments can beneficially address the gap in existing proposals where suitable management mechanism is required for group communication to correctly and efficiently control the message delivery over MBMS, by determining the delivery method, and unicast by coordinating with CN, RAN, and UE.

Beneficially, the above described exemplary embodiments include, although they are not limited to, one or more of the following functionalities:
1. a) The MCE determines the MBMS mechanism for the eNB(s) for a given group communication and indicates the selected MBMS mechanism to the GCS-AS via the intermediate NEs.
1. b) The GCS-AS determines the delivery mechanism (i.e. MBMS or unicast) to the UE based on the obtained information.
2. a) The GCS-AS provides a cell and/or user identity list with the preferred MBMS mechanisms to the MCE e.g. in the MBMS Activate Bearer request message.
2. b) The MCE uses the information to determine the UE capabilities and to take into account the MBMS delivery mechanism on a per UE basis or per cell basis.
3. The GCS-AS correlates the user identity with the device's capability using the device identity as the key.

It can be seen that the above exemplary embodiments describe a method for dynamically determining the MBMS mechanism for the eNB and group member UE.

The method may comprise the steps of:
a) The MCE acquires the eNB capability of the supported MBMS mechanism(s) from the eNB(s) it controls by querying them.
b) The MCE acquires the UE capability of the supported MBMS mechanism(s) from the group member UE(s) which is/are under the cell(s) (eNBs) that the MCE controls.
c) The MCE acquires the knowledge of the mapping between the UE and the cell it is located under.
d) The MCE determines the MBMS mechanism for the eNB(s) for a given group communication and indicates the selected MBMS mechanism to the GCS-AS via the intermediate NEs.
e) The GCS-AS determines the delivery mechanism (i.e. MBMS or unicast) to the UE based on the obtained information.

In some cases, the method may comprise the steps of:
a) The UE provides the user identity and device identity to the GCS-AS.
b) The UE provides the device identity and its capability information to the MCE. The MCE forwards this mapping information to the GCS-AS.
c) The GCS-AS correlates the user identity with the device's capability information using the device identity as the key.

Furthermore, the method may comprise the steps of:
a) The GCS-AS provides a cell and/or user identity list with the preferred MBMS mechanisms to the MCE e.g. in the MBMS Activate Bearer request message.
b) The MCE uses the information to determine the UE capabilities and to take into account the MBMS delivery mechanism on a per UE basis or per cell basis.

It can be seen that the above exemplary embodiments provide a number of benefits. For example, MCE can make a decision of which MBMS mechanism to be used by the eNB, by using information such as:
The UE's supported MBMS mechanism (MBSFN only, or MBSFN and SC-PTM).
The cell the UE is located in.
The cell's (eNB) supported MBMS mechanism (MBSFN only, or MBSFN and SC-PTM).
The preferred MBMS mechanism indicated by the GCS-AS.

Also, the GCS-AS can make a decision of whether MBMS or unicast should be used for a given UE in a group communication, using information such as:
The UE's supported MBMS mechanism (MBSFN only, or MBSFN and SC-PTM).
The cell the UE is located in.
The cell's (eNB) supported MBMS mechanism (MBSFN only, or MBSFN and SC-PTM).
The UE's current delivery mechanism of the group communication

Furthermore, the GCS-AS can use information of the UE's location (cell) and its supported MBMS mechanism in order determine whether to change the delivery method of group communications (for example from MBMS to unicast, or from unicast to MBMS.

It will be appreciated that the exemplary embodiments described herein are particularly applicable to the multicast operation in mission critical services (e.g. MCPTT, MCVideo, MCData). However, this mechanism can be applied to other services also.

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

In the above description, the GCS-AS and the MCE are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (TO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the GCS-AS and/or the MCE as a signal over a computer network, or on a recording medium. Further, the functionality performed by part or all of this software may be performed using one or more dedicated hardware circuits. However, the use of software modules is preferred as it facilitates the updating of the GCS-AS and/or the MCE in order to update their functionalities.

Various other modifications will be apparent to those skilled in the art and will not be described in further detail here

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF ABBREVIATIONS

### 3GPP 3^{rd} Generation Partnership Project

### 4G 4^{TH} Generation

### 5G 5^{th} Generation

### AVP Attribute Value Pair

### BM-SC Broadcast-Multicast Service Center

### DL DownLink

### DL-SCH DownLink Shared Channel

### DRB Data Radio Bearer

eMBMS Evolved MBMS

### EPC Evolved Packet Core

### GAA GCS Action Answer

### GAR GCS Action Request

### GCS-AS Group Communication System Application Server

### GCSE_LTE Group Communication System Enabler for LTE

### GNA GCS Notification Answer

### GNR GCS Notification Request

### IE Information Element

### LTE Long Term Evolution

### MBMS Multimedia Broadcast/Multicast Service

### MBSFN Multicast-Broadcast Single Frequency Network

### MCE Multi-cell/multicast Coordination Entity

### MCPTT Mission Critical Push-To-Talk

### MME Mobility Management Entity

### NE Network Element

### P-GW PDN GateWay

### RAA Re-Auth Answer

### RAR Re-Auth Request

### S-GW Serving GateWay

### SC-MTCH Single Carrier Multicast Traffic Channel

### SC-MCCN Single Carrier Multicast Control Channel

### SC-PTM Single Carrier Point-to-Multipoint

### SIB System Information Block

### UE User Equipment

### UP User Plane

### LIST OF REFERENCES

[1] 3GPP TS 23.468, “Group Communication System Enablers for LTE (GCSE_LTE); Stage 2” ver.12.0.0 (2014-02)
[2] RP-151110, “New WI proposal: Support of single-cell point-to-multipoint transmission in LTE”, Huawei, HiSilicon
[3] RP-142205, “New Study Item Proposal for Support of single-cell point-to-multipoint transmission in LTE”, Huawei, HiSilicon
[4] TR 36.890, “Study on Support of single-cell point-to-multipoint transmission in LTE (SC-PTM)”, Ver.13.0.0 (2015-06)
[5] TS 36.300, “Evolved Universal Terrestrial Radio Access (E-UTRA) and Evolved Universal Terrestrial Radio Access Network (E-UTRAN); Overall description; Stage 2”, Ver13.2.0 (2015-12)
[6] TS 36.444, “Evolved Universal Terrestrial Radio Access Network (E-UTRAN); M3 Application Protocol (M3AP)”, Ver.13.1.0 (2015-12)
[7] TS 36.443, “Evolved Universal Terrestrial Radio Access Network (E-UTRAN); M2 Application Protocol (M2AP)”, Ver.13.2.0 (2015-12)
[8] RP-160298, “New WI proposal SC-PTM enhancements for LTE”, Huawei, HiSilicon, 2016-03
[9] S6-160893, “Pseudo-CR on proposed solution to key issue” (pCR to TR 23.780 at SA6 #12), NEC, 2016-08
[10] S6-160894, “Pseudo-CR on Notification on MBMS bearer activation result” (pCR to TR 23.780 at SA6 #12), Ericsson, 2016-08
[11] 3GPP TS 23.003, “Numbering, addressing and identification”, Ver.14.1.0 (2016-09)
[12] 3GPP TS 23.179, “Functional architecture and information flows to support mission critical communication services stage 2”, Ver.13.3.0 (2016-09)
[13] 3GPP TS 36.331, “Radio Resource Control (RRC) Protocol specification”, Ver.14.0.0 (2016-09)

1. A method performed by a multi-cell/multicast coordination entity (MCE) in a communication system in which a plurality of member user equipments (UEs) can engage in group communication, the method comprising:
obtaining information about a supported multimedia broadcast/multicast service (MBMS) mechanism of a member UE of the plurality of member UEs;
using the obtained information to select a multimedia broadcast/multicast service (MBMS) mechanism for a base station (eNB); and
notifying the selected MBMS mechanism to an application server.

2. The method as claimed in claim 1, wherein the obtaining of the information about the member UE's supported MBMS mechanism includes obtaining the member UE's supported MBMS mechanism via the eNB.

3. The method as claimed in claim 2, wherein the member UE's supported MBMS mechanism is forwarded by the eNB to the MCE after the eNB obtains the member UE's supported MBMS mechanism from the member UE.

4. The method as claimed in claim 1, wherein the obtaining of the information about the member UE's supported MBMS mechanism includes obtaining the member UE's supported MBMS mechanism along with location information for the member UE.

5. The method as claimed in claim 1, further comprising receiving a device identity reported by the member UE.

6. The method as claimed in claim 1, wherein the application server comprises at least a group communication system application server (GCS-AS).

7. The method as claimed in claim 1, wherein the obtaining of the information about the member UE's supported MBMS mechanism includes receiving the member UE's supported MBMS mechanism as capability information from the eNB.

8. The method as claimed in claim 1, wherein the notifying the selected MBMS mechanism to the application server comprises forwarding the selected MBMS mechanism to a mobility management entity (MME).

9. A method performed by an application server in a communication system in which a plurality member user equipments (UEs) can engage in group communications, the method comprising:
receiving, from a multi-cell/multicast coordination entity (MCE), a multimedia broadcast/multicast service (MBMS) mechanism selected by the MCE; and
using the MBMS mechanism selected by the MCE to determine a delivery method for communication to an individual UE of the plurality of member UEs in a group communication.

10. The method as claimed in claim 9, wherein the delivery method is determined from a choice of delivery methods comprising MBMS and unicast.

11. The method as claimed in claim 9, wherein the MBMS mechanism selected by the MCE is received by the application server by from the MCE via a mobility management entity (MME), MBMS gateway (MBMS-GW), and a broadcast-multicast service center (BM-SC).

12. The method as claimed in claim 9, further comprising receiving a device identity reported by the individual UE.

13. The method as claimed in claim 12, further comprising correlating the device identity with an application level identity.

14. The method as claimed in claim 13, wherein the correlating further comprises correlating the device identity and the application level identity with a capability and with a location of the individual UE.

15. A multi-cell/multicast coordination entity (MCE) for a communication system in which a plurality of member user equipments (UEs) can engage in group communication, the MCE comprising:
a processor and a transceiver, wherein the processor is configured to:
obtain information about a supported multimedia broadcast/multicast service (MBMS) mechanism of a member UE of the plurality of member UEs;
use the obtained information to select a multimedia broadcast/multicast service (MBMS) mechanism for a base station (eNB); and
control the transceiver to notify the selected MBMS mechanism to an application server.

16. An application server for a communication system in which a plurality of member user equipments (UEs) can engage in group communications, the application server comprising:
a processor and a transceiver wherein the processor is configured to:
receive, from a multi-cell/multicast coordination entity (MCE), a multimedia broadcast/multicast service (MBMS) mechanism selected by the MCE; and
use the MBMS mechanism selected by the MCE to determine a delivery method for communication to an individual UE of the plurality of member UEs in a group communication.
